(19) United States
(12) Patent Application Publication
(10) Pub. No.: US 2015/0112755 A1
(43) Pub. Date: Apr. 23, 2015

(54) Automated Identification and Evaluation of Business Opportunity Prospects

(71) Applicants: SUSHANT POTDAR, Palo Alto, CA (US); BRIAN YIP, Palo Alto, CA (US); PRAVEEN KALLA, Palo Alto, CA (US); PRERNA MAKANAWALA, Palo Alto, CA (US); KE SUN, Palo Alto, CA (US); KEDAR SHIROOR, Palo Alto, CA (US); NIYANTH KUDUMULA, Palo Alto, CA (US); ABHIJIT MITRA, Palo Alto, CA (US); KARAN SOOD, Palo Alto, CA (US)

(72) Inventors: SUSHANT POTDAR, Palo Alto, CA (US); BRIAN YIP, Palo Alto, CA (US); PRAVEEN KALLA, Palo Alto, CA (US); PRERNA MAKANAWALA, Palo Alto, CA (US); KE SUN, Palo Alto, CA (US); KEDAR SHIROOR, Palo Alto, CA (US); NIYANTH KUDUMULA, Palo Alto, CA (US); ABHIJIT MITRA, Palo Alto, CA (US); KARAN SOOD, Palo Alto, CA (US)

(73) Assignee: SAP AG, Walldorf (DE)

(21) Appl. No.: 14/057,978

(22) Filed: Oct. 18, 2013

(51) Int. Cl. G06Q 30/02

(52) U.S. Cl. CPC G06Q 30/0201
USPC 705/7.29

(57) ABSTRACT

Embodiments identify and evaluate business opportunity prospects in an automated fashion. An engine receives one or more inputs used to identify business opportunities. These input(s) can comprise recent events gathered from external sources, for example feeds from news websites, and/or publicly-available business information (e.g. compiled by third parties). Other inputs can comprise information from internal sources, such as Enterprise Resource Planning (ERM) and/or Customer Relationship Management (CRM) applications. Still other inputs can comprise personalized user preferences, for example an industry and/or territory assigned to a particular user. From these input(s), the engine automatically generates a business lead, together with a score reflecting a strength of that lead. To this existing lead information (e.g. score, lead name, lead contact information, etc.), a user can manually add further information, for example monetary value and/or an closing date, in order to create a deal pipeline for visualization.

### BACKGROUND

Embodiments relate to the analysis of business information, and in particular to systems and methods configured to automatically identify and evaluate business opportunity prospects.

Business entities are continuously seeking to identify promising new business opportunities. Such business opportunities may arise within the context of existing client relationships, or may arise with prospective new clients.

Often, information that can lead to the discovery of new promising business opportunities (e.g. news reports, personal contacts, existing client needs) may be present in different locations, and possessed by different individuals. This lack of a centralized knowledge base can interfere with coordinated efforts in developing leads, delaying or even precluding an entity from effectively capitalizing upon a promising business opportunity.

This issue becomes more acute in larger business entities. In such environments, institutional knowledge relevant to a promising business opportunity may be distributed across a variety of individuals, who may be dispersed over a wide geographic area and operate within different business units.

Accordingly, there is a need in the art for systems and methods that allow automated identification and evaluation of business opportunity prospects.

### SUMMARY

Embodiments identify and evaluate business opportunity prospects in an automated fashion. An engine receives one or more inputs used to identify business opportunities. These input(s) can comprise recent events gathered from external sources, for example feeds from news websites, and/or publicly-available business information (e.g. compiled by third parties). Other inputs can comprise information from internal sources, such as Enterprise Resource Planning (ERM) and/or Customer Relationship Management (CRM) applications. Still other inputs can comprise personalized user preferences, for example an industry and/or territory assigned to a particular user. From these input(s), the engine automatically generates a business lead, together with a score reflecting a strength of that lead. To this existing lead information (e.g. score, lead name, lead contact information, etc.), a user can manually add further information, for example monetary value and/or an closing date, in order to create a deal pipeline for visualization.

An embodiment of a method comprises providing an engine in communication with a public data source and a private data source, and causing the engine to receive a first input comprising public information from the public data source, a second input comprising private information from the private data source, and a third input comprising a user preference. The engine is caused to process the first input, the second input, and the third input to identify a business lead and to compute a score reflecting a strength of the business lead. The engine is caused to display the business lead and the score to a user.

An embodiment of a computer system comprises a processor and a non-transitory computer readable medium having stored thereon one or more programs, which when executed by the processor, causes the processor to provide an engine in communication with a public data source and a private data source. The engine is caused to receive a first input comprising public information from the public data source, a second input comprising private information from the private data source, and a third input comprising a user preference. The engine is caused to process the first input, the second input, and the third input to identify a business lead and to compute a score reflecting a strength of the business lead. The engine is caused to display the business lead and the score to a user.

An embodiment of a non-transitory computer readable storage medium stores one or more programs comprising instructions for providing an engine in communication with a public data source and a private data source. The engine is caused to receive a first input comprising public information from the public data source, a second input comprising private information from the private data source, and a third input comprising a user preference. The engine is caused to process the first input, the second input, and the third input to identify a business lead and to compute a score reflecting a strength of the business lead. The engine is caused to display the business lead and the score to a user.

In certain embodiments the first input, the second input, and the third input are displayed as a tag cloud for selection by the user.

According to some embodiments the first input comprises data from a news feed or publicly available business data, and the second input comprises private business data from a customer relationship management application or from an enterprise resource planning application.

In various embodiments the score is computed based upon an order in which the first input and the second input are entered by a user.

According to particular embodiments the engine is in an in-memory database, and the engine references a stored library of the in-memory database during processing of the first input, the second input, and the third input to identify the business lead and to compute the score.

Some embodiments further comprise storing the business lead as a data object including the score and a name of the business lead.

According to certain embodiments the user preference is derived from a customer relationship management application.

The following detailed description and accompanying drawings provide a better understanding of the nature and advantages of the present disclosure.

### BRIEF DESCRIPTION OF THE DRAWINGS

FIG. 1 is a simplified diagram illustrating an embodiment of a system.

FIG. 2 is a flow diagram showing process steps according to an embodiment.

FIG. 3 shows a simplified view of an exemplary system embodiment implemented in the context of an in-memory database.

FIGS. 4-6 show simplified screen shots of a user interface according to an embodiment.

FIG. 7 illustrates hardware of a special purpose computing machine configured with a method according to the above disclosure.

FIG. 8 illustrates an exemplary computer system.

FIG. 9 illustrates a high level system according to one embodiment.

FIG. 10 illustrates a system according to one embodiment.

### DETAILED DESCRIPTION

Described herein are techniques for automatic identification and evaluation of business opportunity prospects. This concept is also referred to herein as a “Deal Finder”. The apparatuses, methods, and techniques described below may be implemented as a computer program (software) executing on one or more computers. The computer program may further be stored on a tangible non-transitory computer readable medium, such as a memory or disk, for example. A computer readable medium may include instructions for performing the processes described below. In the following description, for purposes of explanation, numerous examples and specific details are set forth in order to provide a thorough understanding of the present invention. It will be evident, however, to one skilled in the art that embodiments defined by the claims may include some or all of the features in these examples alone or in combination with other features described below, and may further include modifications and equivalents of the features and concepts described herein.

Embodiments identify and evaluate business opportunity prospects in an automated fashion. An engine receives one or more input(s) used to identify business opportunities. These input(s) can comprise recent events gathered from external sources, for example news feeds from websites, and/or publicly-available business information compiled by third parties. Other inputs can comprise information from internal sources, such as Enterprise Resource Planning (ERM) and/or Customer Relationship Management (CRM) applications. Still other inputs can comprise personalized user preferences, for example assigned industry responsibility. From these input(s), the engine automatically generates a business lead, together with a score reflecting a strength of the lead. To this existing lead information (e.g. score, lead name, lead contact information, etc.), a user can manually add further information, for example monetary value and/or an closing date, in order to create a deal pipeline.

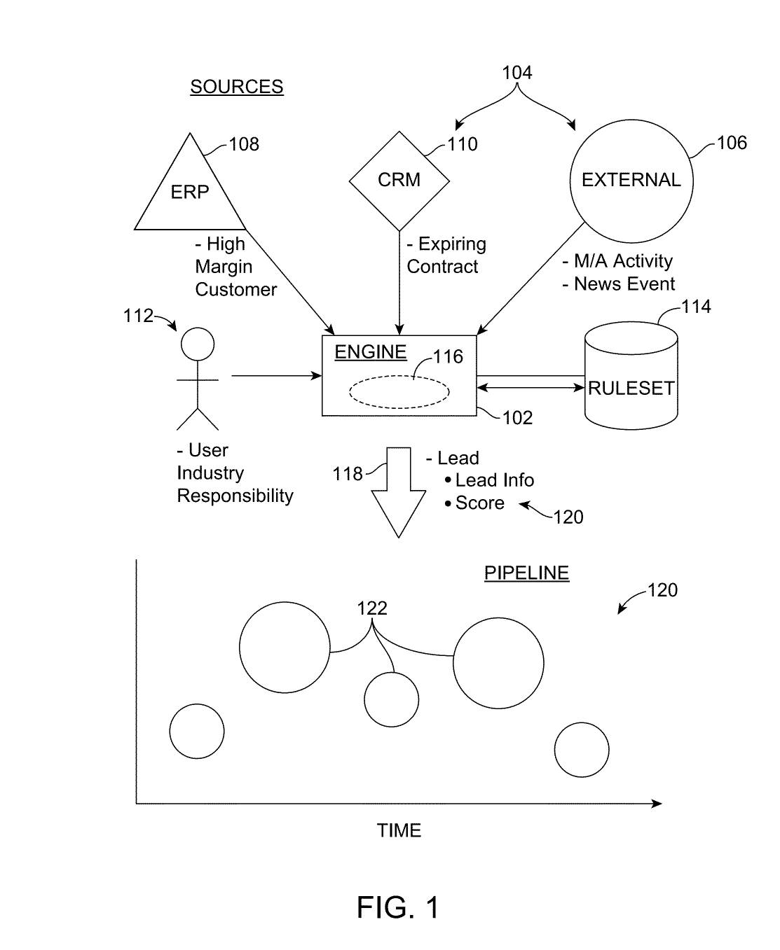

FIG. 1 shows a simplified view of a system 100 according to an embodiment. In particular, system 100 comprises an engine 102 configured to receive a plurality of inputs from different data source types 104.

One type of data source 104 may comprise external information 106. Such external information may comprise syndication feeds (e.g. RSS) concerning news events. For example, a reported news event regarding a drug shortage may have possible relevance to the identification and evaluation of a possible lead in the pharmaceutical industry.

Such external information may also comprise data (e.g. business information) compiled by third parties based upon public disclosures. For example, a substantial drop in income reported by drug company, could have possible relevance to identifying and evaluating a possible lead regarding customers or competitors of that drug company. Such business information may be available directly from public sources (e.g. filings with the Securities and Exchange Commission), or may be available from third parties responsible for compiling and consolidating such information (e.g. ONESOURCE of Concord, Mass.).

Other examples of external information that may be considered in identifying and evaluation a business opportunity according to embodiments, may include but are not limited to:

Executive Changes

Employee Headcount Changes

Mergers and Acquisitions

Hiring Initiatives

Stock Changes

Product Releases

Product Names

Asset Changes

The engine 102 may receive inputs from internal, non-public sources in order to automatically identify and evaluate business opportunities. For example, the engine may be configured to receive inputs from an Enterprise Resource Planning (ERP) system 108. In one example, the ERP system could provide to the engine, an input identifying certain existing “High Margin Customers”, with whom a new business opportunity might be expected to generate significant amounts of revenue.

Such information may be available directly from the ERP system itself. Alternatively, this information may be available indirectly, on the basis of data mining activities performed on the basis of information available from the ERP system.

Still another possible source of internal information that may be relevant to lead identification and evaluation according to embodiments, is a Customer Relationship Management (CRM) system 110. In one example, the CRM system could provide to the engine, an input identifying a specific existing customer whose current contract is due to expire soon. Such a customer may be receptive to establishing an expanded or shifted business relationship.

Examples of other internal information that may be considered in identifying and evaluation a business opportunity according to embodiments, may include but are not limited to:

Customer Name

Customer Contacts

Revenue from Customer

Margin from Customer

Executive Changes

Contract with Customer

Competitors of Customer

Vendors of Customer

Suppliers of Customer

Internal Client Team Members

Yet another possible source of internal information that may be relevant to lead identification and evaluation, are personal preferences of a user 112. In one example, the user could comprise a member of a sales team having particular responsibility for lead generation in a specific industry, within a prescribed geographic area. Such industry and/or territory information may be input to the engine, and be considered in identifying a possible lead and assigning a score thereto.

Examples of user preferences that may be considered in identifying and evaluation a business opportunity according to embodiments, may include but are not limited to:

User Assigned Territory

User Assigned Industry

User Involvement in Past Opportunities

User Internal Contacts

Value of Past Opportunities

User External Contacts (e.g. through social media)

User Internal Contacts (including past and existing job titles and team memberships)

Based upon the inputs received, the engine 102 is configured to reference a ruleset 114 and execute one or more algorithms 116 to generate an output 118. As previously mentioned, the output may be a lead comprising lead information (e.g. target name, target contact particulars) and also a numerical score reflecting a relative strength of the lead. As described further below, the lead may be in the form of a data object.

Operation of the system 100, is now described in connection with a simple example. A user may be responsible for developing leads for in the pharmaceutical industry in Asia, with one input to the engine reflecting these user preferences.

The engine may receive as an additional input, a first news feed indicating a shortage of a drug in a specific Asian nation. A second news feed input to the engine may indicate a shortage of the same drug in a European nation.

Finally, the engine may receive from a CRM program, information regarding a first customer responsible for selling drugs in Europe, and a second customer responsible for selling drugs in Asia.

Based on these inputs, the engine may reference a ruleset and an algorithm to come up with possible business leads for the user. Under these circumstances, both the first customer and the second customer may be identified as leads by the engine. However, owing to the user's personal preferences (e.g. responsibility for lead generation in Asia), the lead corresponding to the second customer would likely receive a higher score than the lead corresponding to the first (European) customer.

FIG. 1 goes on to show the leads 122 identified by the engine, visualized in the form of a pipeline 120. This pipeline figure may reflect further information that is contributed by a user following identification of the lead.

One example of such added information may include the monetary value of the lead (as represented by a size of the lead icon—here a circle). Another example of such added information may include an expected closing date by which the lead is expected to mature into an actual agreement (as represented by the location of the circle along the x-axis of the pipeline designating time).

In certain embodiments, the lead information and the score may also be displayed in the pipeline figure. In alternative embodiments, lead information and score (including, for example, the actual inputs on which the lead is based) may be made available by the user clicking on a display element.

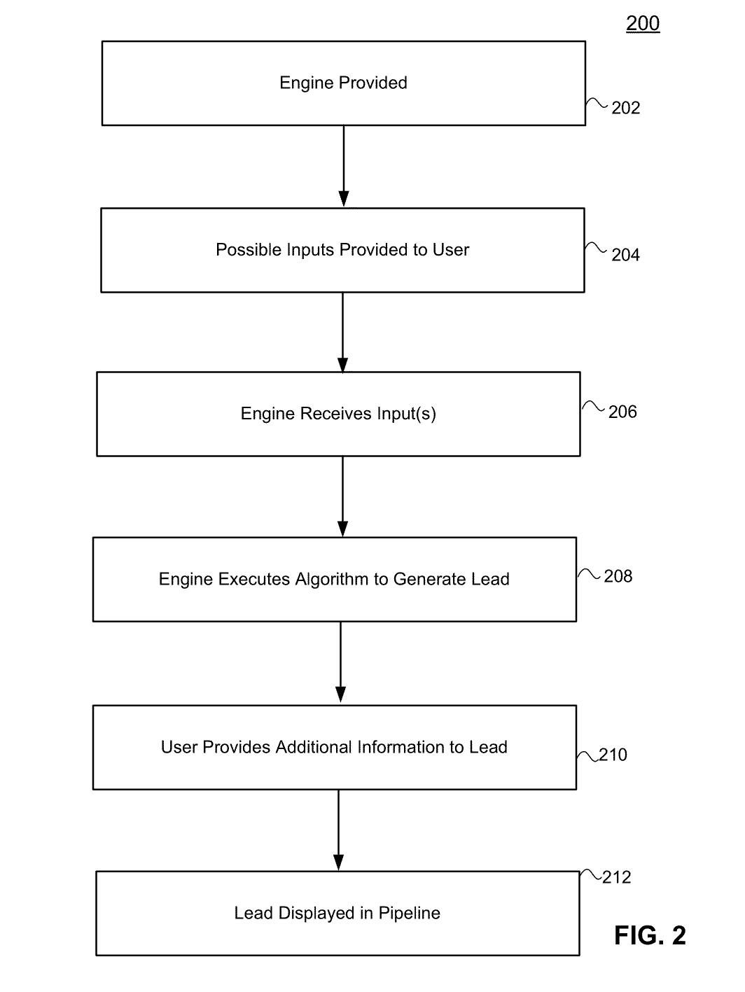

FIG. 2 is a simplified diagram illustrating a flow of a process 200 according to an embodiment. In a first step 202, an engine configured to execute an algorithm is provided in communication with a ruleset.

In an optional step 204, one or more inputs relevant to potential business opportunities and derived from different sources, are provided to a user. In certain embodiments, these inputs may be presented in the form of a tag cloud.

In a third step 206, the engine receives the input(s). In a fourth step 208, the engine executes the algorithm on the input(s), to generate an output of a lead comprising lead information and a lead score.

In a fifth, optional step 210, the user provides additional data to add to the lead information. In a sixth, optional step 212, the lead is displayed as part of a pipeline.

### EXAMPLE

One specific example of implementation of an embodiment is now provided in the context of a database system. In particular, this example utilizes the processing power of the HANA in-memory database available from SAP AG of Walldorf, Germany.

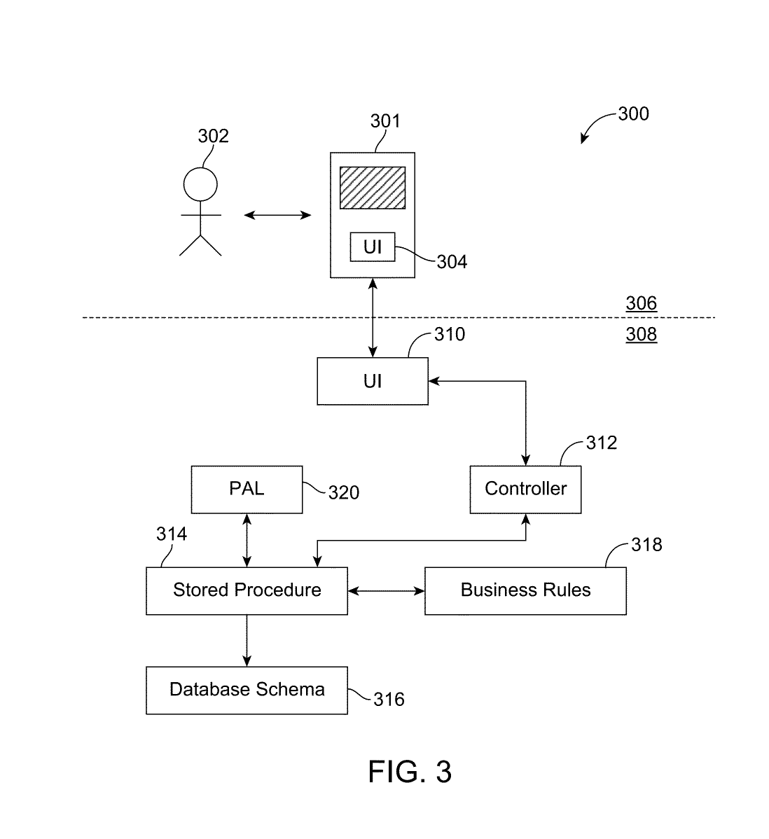

FIG. 3 shows an overview of the exemplary system 300. In particular, using a mobile device 301, a user 302 interacts with a user interface 304 component of an application layer 306 overlying a database layer 308. This user interface component of the application layer may be resident on a mobile device of the user, who may enter inputs directly to an application present on the mobile device. The user may access the application via a client-server relationship. As described above, the input from the user may comprise personal user preferences, external data (e.g. RSS, compiled business info), and/or internal data (e.g. from CRM, ERP).

User inputs received by the interface 304, are communicated to a user interface component 310 of the database layer. These instructions are in turn communicated to a controller 312, which then selects from a set of stored procedures 314 to perform the lead identification and evaluation function.

In performing this lead identification and evaluation function, the stored procedures 314 may manipulate lead-relevant data present in an underlying database schema 316. Most commonly, the lead-relevant data is organized in the form of tables.

The stored procedures 314 may also reference certain business rules 318 that determine the relation between that lead-relevant data. For example, the lead may be structured in the form of a data object comprising constituent fields in the form of lead name, lead contact person, and/or lead score.

In executing algorithms to identify and evaluate the lead, the stored procedure may reference one or more libraries 320, here the Predictive Analysis Libraries (PAL) of the HANA in-memory database of SAP AG. Algorithm(s) stored in this library may be applied in specific ways for lead generation.

In a particular embodiment, an order in which a user enters multiple inputs, may dictate the relative importance afforded those inputs in determining the lead score. Thus a first clustering algorithm may consider multiple inputs (e.g. RSS, ERP data, CRM data, and preferences) in identifying the existence of a possible lead. A second algorithm may then assign a relative weight to the importance of these inputs in evaluating the viability of the lead, as reflected by the lead score.

Thus where the user enters an RSS feed (e.g. drug shortage) as a first input, and enters ERP data (e.g. high margin client) as a second input, the drug shortage would have more influence in calculating the lead score, than the ERP data. According to this embodiment, then, a first potential lead selling drugs to the market experiencing a shortage, would have a higher lead score than a second potential lead merely having a high margin.

Based upon the results of the computation of the stored procedures, a corresponding output is returned to the controller. This output is then forwarded from the database layer to the user interface on the mobile device.

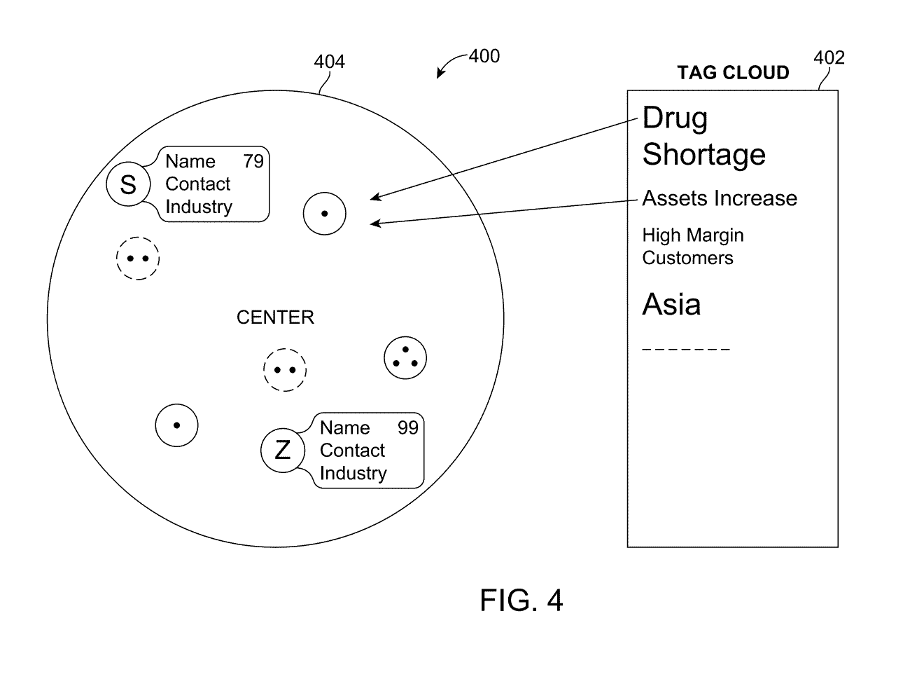

FIG. 4 shows one example of a possible user interface screen 400. In particular, a listing of possible inputs 402 are presented in the box on the right. These possible inputs may be presented in the form of a tag cloud.

The possible inputs shown in FIG. 4 include external news items (“Drug Shortage”), external public business information (“Assets Increase”), internal CRM data (“Expiring Contracts”), internal ERP data (“High Margin Customers”), and user preferences (“Asia”). By selecting (clicking) and moving (dragging) these possible inputs from the box to the circle portion 404 of the display, these inputs are communicated to the stored procedures on the database layer.

FIG. 4 shows that as a result of processing of these inputs, the user interface displays the corresponding leads and their scores. The manner of display of the lead may indicate its source—for example a dashed circle may indicate a lead with an existing customer, a solid circle may indicate a lead with a new customer. Color may also be used to communicate information relevant to particular leads.

To facilitate alerting a user to particularly promising leads (i.e. having high lead scores), in certain embodiments the interface may display those leads with an icon of the target. Leads having a lower lead score, may be displayed more generically, for example with a number of dots reflecting a relative importance.

The interface may be dynamic, with the user having the ability to remove leads by dragging them out of the circle. The interface will then update, possibly changing the manner of display of the next most important leads in order to emphasize their increased relative strength (for example by changing them to an icon). The interface may also allow user interaction by selecting a lead within to provide additional information (e.g. a pop-up showing the lead name, and contact information).

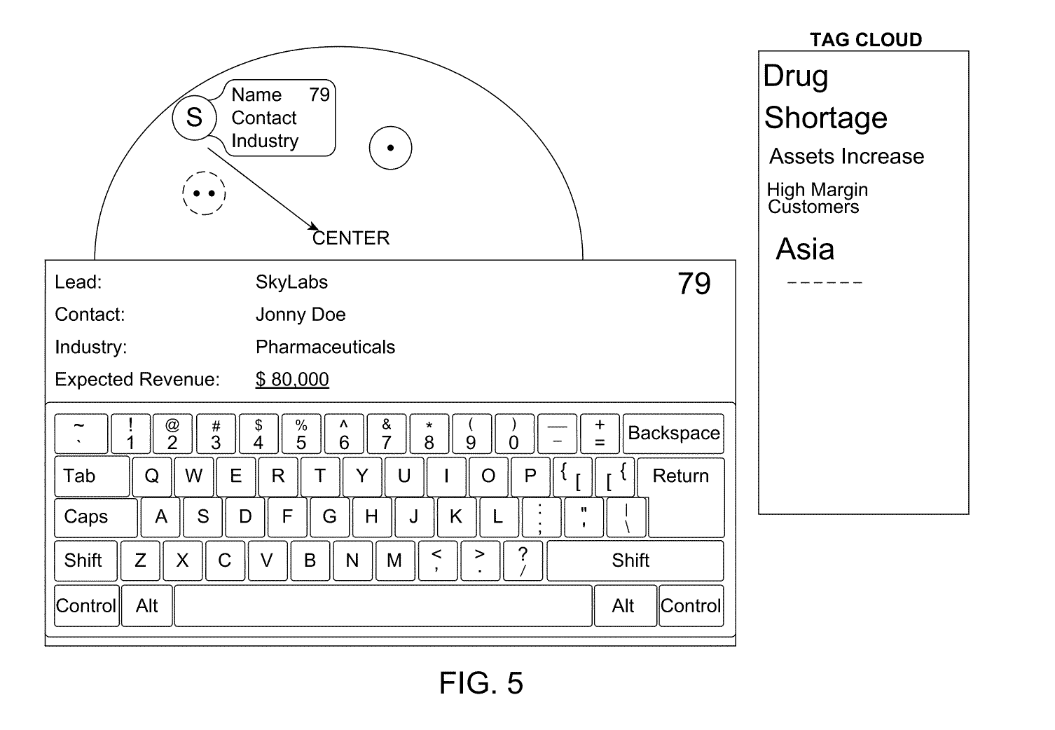

By moving a lead to a center of the circle, it may be added to a pipeline figure. As shown in FIG. 5, this may prompt a screen to allow the user to manually enter additional information (e.g. a monetary value and/or an expected date of maturity for the particular lead into a business relationship).

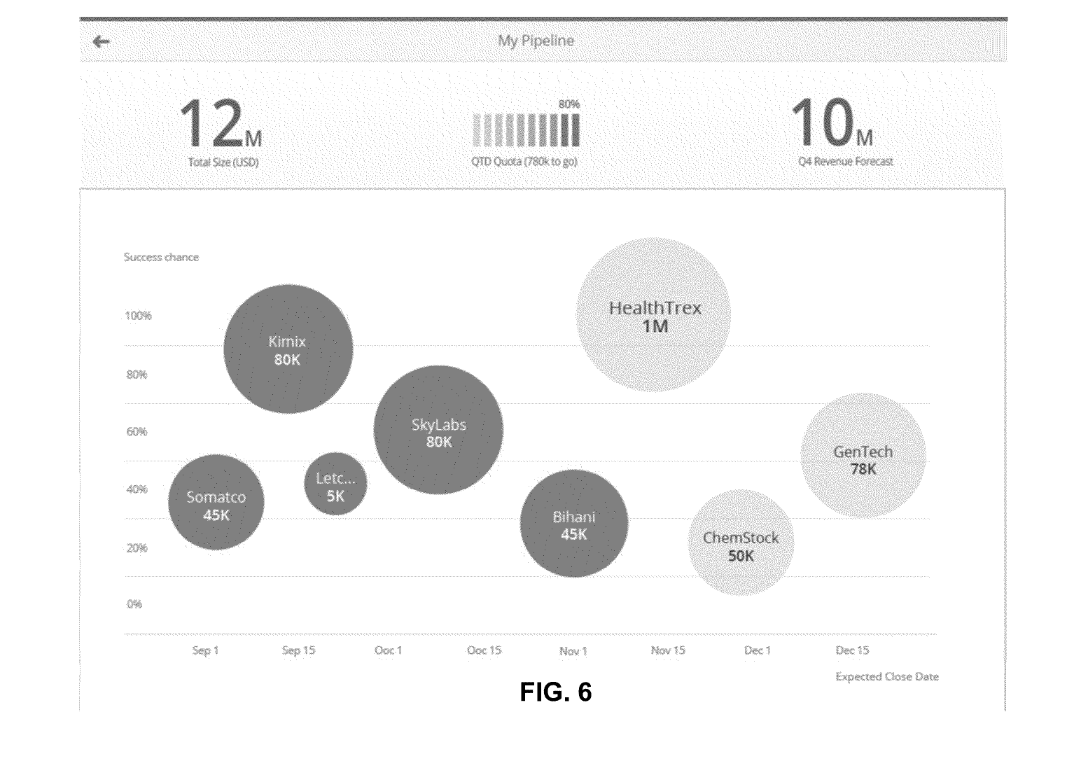

FIG. 6 shows a corresponding display of the lead in a pipeline figure. The lead is indicated by a circle, with the relative size of the circle indicating a monetary value. The location of the circle along the x-axis indicates its expected date of completion. A shading of the circle may indicate the lead's status as merely preliminary, or instead more developed.

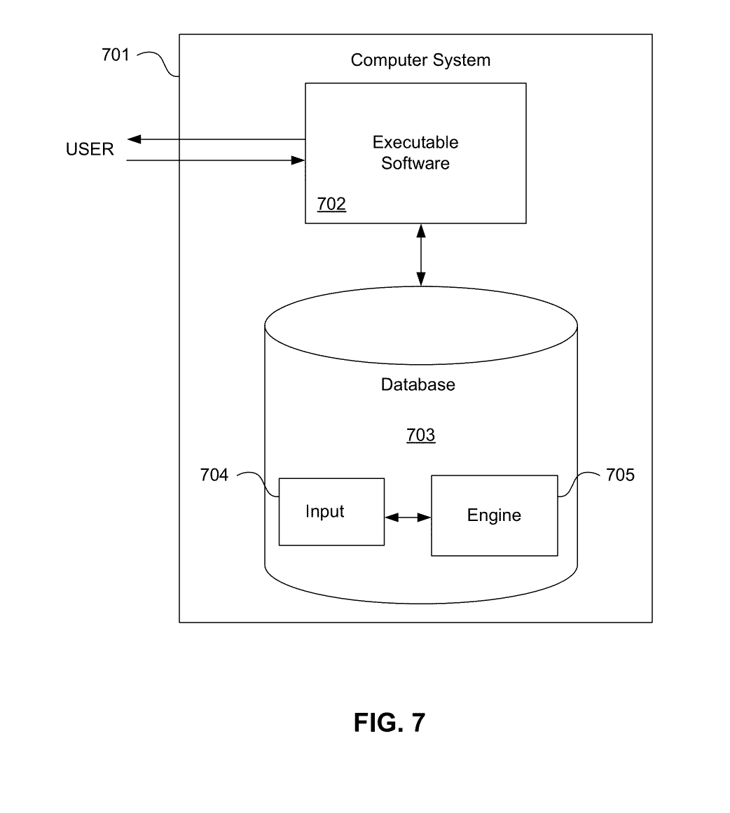

FIG. 7 illustrates hardware of a special purpose computing machine configured with a process according to the above disclosure. The following hardware description is merely one example. It is to be understood that a variety of computers topologies may be used to implement the above described techniques. In particular, computer system 700 comprises a processor 702 that is in electronic communication with a non-transitory computer-readable storage medium 703. This computer-readable storage medium has stored thereon code 704 corresponding to an input. Code 705 corresponds to an engine. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

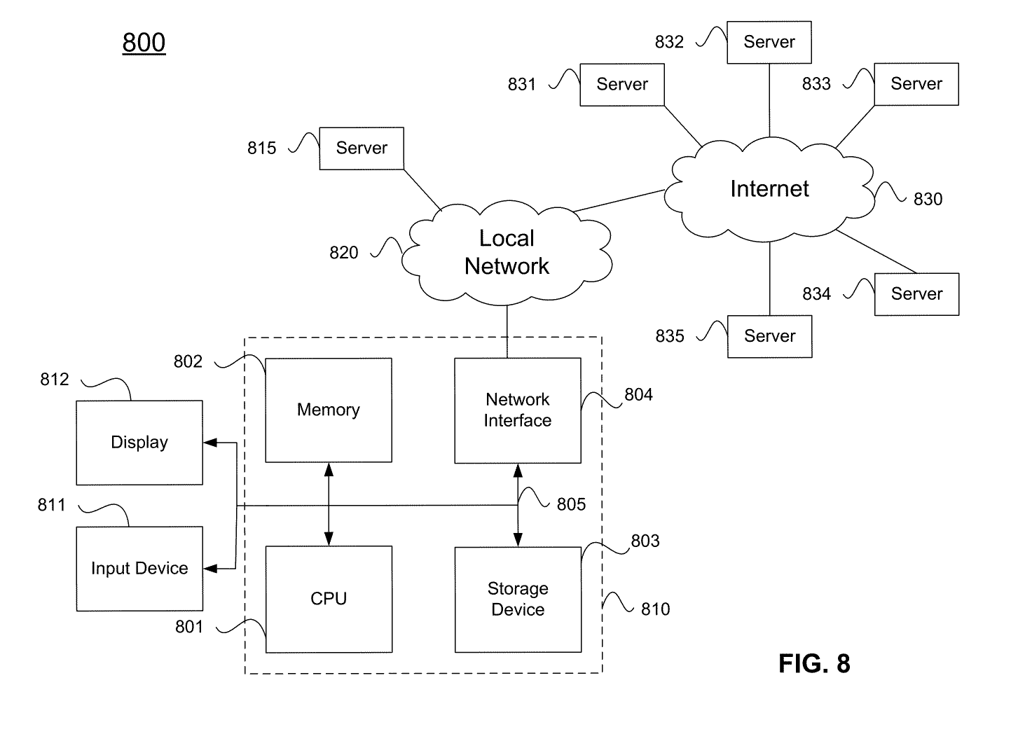

An example system 800 is illustrated in FIG. 8. Computer system 810 includes a bus 805 or other communication mechanism for communicating information, and one or more processor(s) 801 coupled with bus 805 for processing information. Computer system 810 also includes a memory 802 coupled to bus 805 for storing information and instructions to be executed by processor 801, including information and instructions for performing some of the techniques described above, for example. This memory may also be used for storing programs executed by processor 801. Possible implementations of this memory may be, but are not limited to, random access memory (RAM), read only memory (ROM), or both. A storage device 803 is also provided for storing information and instructions. Common forms of storage devices include, for example, a hard drive, a magnetic disk, an optical disk, a CD-ROM, a DVD, a flash or other non-volatile memory, a USB memory card, or any other medium from which a computer can read. Storage device 803 may include source code, binary code, or software files for performing the techniques above, for example. Storage device and memory are both examples of non-transitory computer readable storage mediums.

Computer system 810 may be coupled via bus 805 to a display 812 for displaying information to a computer user. An input device 811 such as a keyboard, touchscreen, and/or mouse is coupled to bus 805 for communicating information and command selections from the user to processor 801. The combination of these components allows the user to communicate with the system. In some systems, bus 805 represents multiple specialized buses, for example.

Computer system 810 also includes a network interface 804 coupled with bus 805. Network interface 804 may provide two-way data communication between computer system 810 and a local network 820. The network interface 804 may be a wireless or wired connection, for example. Computer system 810 can send and receive information through the network interface 804 across a local area network, an Intranet, a cellular network, or the Internet, for example. One example implementation may include a browser executing on a computing system 810 that renders interactive presentations that integrate with remote server applications as described above. In the Internet example, a browser, for example, may access data and features on backend systems that may reside on multiple different hardware servers 831-835 across the network. Servers 831-835 and server applications may also reside in a cloud computing environment, for example.

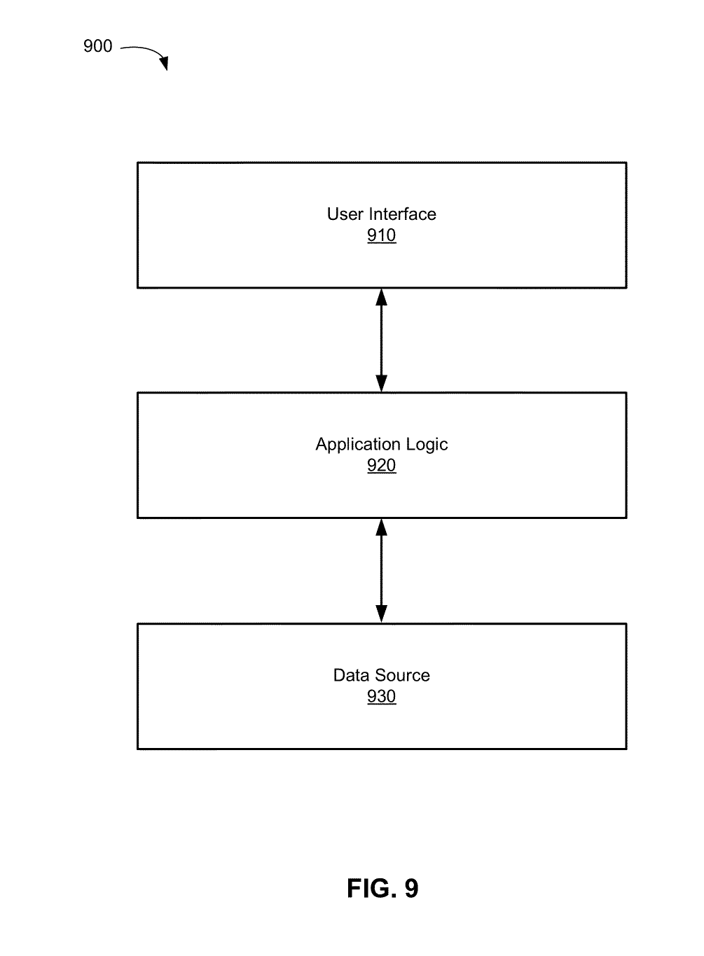

FIG. 9 illustrates a high level system 900 according to one embodiment. System 900 is an application implemented in computer code that can be executed on the server side, the client side, or a combination of both. In one embodiment, system 900 is executed using a plurality of computers communicating with one another via the Internet to provide sales tools in the cloud for selling sales items. A sales item can be a product or service that is placed on sale or available for license. For example, a product for sale can be a pharmaceutical drug, a service for sale can be housekeeping services, and a product for license can be a software license for a software application. Each sales tool can be configured for a different phase of the sales process. In some embodiments, the sales tools provided can include identifying sales opportunities to sell sales items to customers, predicting the outcome of a given sales opportunity, identifying key decision maker for a sales opportunity, and recommending influential people that can help convert the sales opportunity into a successful sales deal.

System 900 includes user interface layer 910, application logic layer 920, and data source layer 930. Data source layer 930 includes a variety of data sources containing data that is analyzed by sales tools stored in application logic layer 920. In one example, data source layer 930 includes data about a company. This can include information about the sales force of the company, information about the sales items that the company offers for sale, and information about customers of the company. In another example, data source layer 930 includes data about sales opportunities. This can include information about potential customers and existing customers, such as customer needs, prior sales deals, and other data related to the customer. In yet another example, data source layer 930 includes information about salespeople outside the company. In yet other examples, other types of data related to the company, competing companies, sales items, and customers can be stored in data source layer 930. For instance, news related to sales items (e.g., recalls, updates to FDA approval, etc.) and customers (e.g., upcoming IPOs, lawsuits, etc.) can also be a part of data source 930. In some embodiments, the data sources that make up data source layer 930 can be stored both locally and remotely. For example, company sensitive information such as information about existing customers or the sales force of the company can be stored and managed in local databases that belong to the company while information about other salespeople not within the company can be periodically retrieved from a remote source such as a social networking website.

Application logic layer 920 is coupled to data source layer 930. Application logic layer 920 includes one or more sales tools that can be utilized by a sales force to help each salesperson in the sales force successfully close sales deals. The sales tools can analyze the collective knowledge available from data source layer 930 to predict the outcome of a sales opportunity. The sales tool can also provide recommendations that may improve the chance of success of the sales opportunity. In one embodiment, a sales tool can be a deal finder that helps a salesperson identify potential deals (e.g., sales opportunities) with existing and potential clients. In another embodiment, a sales tool can be a deal playbook that helps a salesperson identify the combination of sales team, sales items, and/or sales entities that would most likely lead to a successful sales deal. The sales team can include people that the salesperson directly knows and people that the salesperson does not directly know. People that the salesperson does not directly know but can improve the success rate of the sales deal are known as key influencers. In another embodiment, a sales tool can be a spiral of influence that identifies people who can potentially influence the outcome of the sales opportunity. In one example, this can include the key influencers mentioned above. In another example, the spiral of influence can evaluate relationships between the salesperson and a key influencer to identify people who can potentially introduce the salesperson to the key influencer. This can include analyzing relationship information of the sales force and ranking the relationship information to derive a strength of influence for each person that can potentially introduce the given salesperson to the key influencer.

User interface layer 910 is coupled to application logic layer 920. User interface layer 910 can receive user input for controlling a sales tool in application logic layer 920. User interface layer 910 can interpret the user input into one or more instructions or commands which are transmitted to application logic layer 920. Application logic layer 920 processes the instructions and transmits the results generated from application logic layer 920 back to user interface layer 910. User interface layer 910 receives the results and presents the results visually, audibly, or both. In one embodiment, user interface layer 910 can present a landing page that presents information related to a particular user such as information on existing and future sales opportunities and sales deals. The status of sales opportunities can be monitored and tasks can be performed from the landing page.

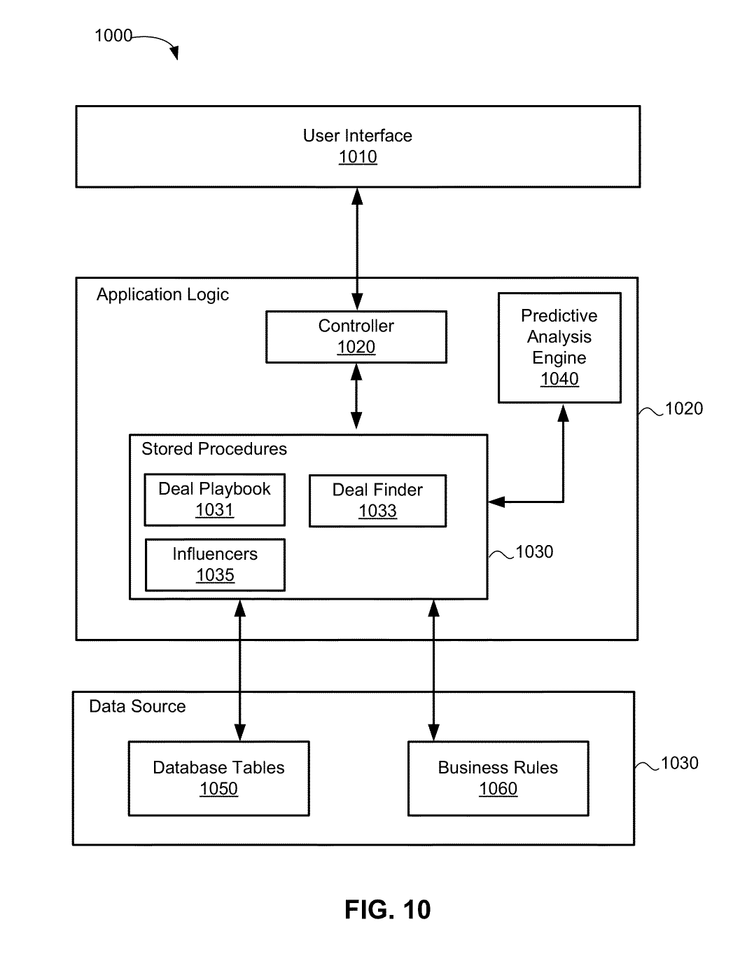

FIG. 10 illustrates a system 1000 according to one embodiment. System 1000 is an application implemented in computer code that can be executed on the server side, the client side, or both. For example, user interface 910 can be executed on the client while application logic 920 and data source 930 can be executed on one or more servers. System 1000 can be a sales application for selling sales items. In one embodiment, system 1000 includes multiple sales tools that can be combined to manage and monitor sales opportunities and sales deals. Application logic 920 includes controller 1020, stored procedures 1030, and predictive analysis engine 1040. Controller 1020 is configured to control the operations of system 1000. Controller 1020 receives user input from user interface 910 and translates the user input into a command which is communicated to stored procedures 1030. A procedure from stored procedures 1030 that corresponds with the command can be called by controller 1020 to process the command. Stored procedures 1030 can include a deal playbook 1031, deal finder 1033, influencers 1035, and other sales tools.

When processing the command, the procedure (which can be one of deal playbook 1031, deal finder 1033, or influencers 1035) can communicate with data source 930. More specifically, the procedure can retrieve data from database tables 1050 and business rules 1060 of data source 930 for analysis. Database tables 1050 can store data in different tables according to the data type and business rules 1060 can store rules to be met when stored procedures 1030 processes the data in database tables 1050. In one example, each database table in database tables 1050 can store a type of data. The analysis performed by the procedure can include transmitting data retrieved from database tables 1050 to predictive analysis engine 1040 for processing. Predictive analysis engine 1040 can be configured to analyze received data or rules to provide predictions. In some embodiments, the predictions can include potential sales opportunities for a particular salesperson, the outcome of a potential sales opportunity, and influential people who can help transform a sales opportunity into a successful sales deal. Once results are generated by the procedure of stored procedures 1030, the results can be communicated to controller 1020, which in turn communicates the results to user interface 910 for presentation to the user.

The above description illustrates various embodiments and their implementation in an example. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method comprising:
providing an engine in communication with a public data source and a private data source;
causing the engine to receive a first input comprising public information from the public data source, a second input comprising private information from the private data source, and a third input comprising a user preference;
causing the engine to process the first input, the second input, and the third input to identify a business lead and to compute a score reflecting a strength of the business lead; and
causing the engine to display the business lead and the score to a user.

2. The method of claim 1 further comprising displaying the first input, the second input, and the third input as a tag cloud for selection by the user.

3. The method of claim 1 wherein:
the first input comprises data from a news feed or publicly available business data; and
the second input comprises private business data from a customer relationship management application or from an enterprise resource planning application.

4. The method of claim 1 wherein the score is computed based upon an order in which the first input and the second input are entered by a user.

5. The method of claim 1 wherein:
the engine is in an in-memory database; and
the engine references a stored library of the in-memory database during processing of the first input, the second input, and the third input to identify the business lead and to compute the score.

6. The method of claim 5 further comprising storing the business lead as a data object including the score and a name of the business lead.

7. The method of claim 1 wherein the user preference is derived from a customer relationship management application.

8. A computer system comprising:
a processor; and
a non-transitory computer readable medium having stored thereon one or more programs, which when executed by the processor, causes the processor to:
provide an engine in communication with a public data source and a private data source;
cause the engine to receive a first input comprising public information from the public data source, a second input comprising private information from the private data source, and a third input comprising a user preference;
cause the engine to process the first input, the second input, and the third input to identify a business lead and to compute a score reflecting a strength of the business lead; and
cause the engine to display the business lead and the score to a user.

9. The computer system of claim 8 wherein the one or more programs are further configured to display the first input, the second input, and the third input as a tag cloud for selection by the user.

10. The computer system of claim 8 wherein:
the first input comprises data from a news feed or publicly available business data; and
the second input comprises private business data from a customer relationship management application or from an enterprise resource planning application.

11. The computer system of claim 8 wherein the score is computed based on an order in which the first input and the second input are entered by a user.

12. The computer system of claim 8 wherein:
the engine is in an in-memory database; and
the engine references a stored library of the in-memory database during processing of the first input, the second input, and the third input to identify the business lead and to compute the score.

13. The computer system of claim 12 wherein the one or more programs further cause the processor to store the business lead as a data object including the score and a name of the business lead.

14. The computer system of claim 8 wherein the user preference is derived from a customer relationship management application.

15. A non-transitory computer readable storage medium storing one or more programs, the one or more programs comprising instructions for:
providing an engine in communication with a public data source and a private data source;
causing the engine to receive a first input comprising public information from the public data source, a second input comprising private information from the private data source, and a third input comprising a user preference;
causing the engine to process the first input, the second input, and the third input to identify a business lead and to compute a score reflecting a strength of the business lead; and
causing the engine to display the business lead and the score to a user.

16. The non-transitory computer readable storage medium of claim 15 wherein the one or more programs further provide instructions for displaying the first input, the second input, and the third input as a tag cloud for selection by the user.

17. The non-transitory computer readable storage medium of claim 15 wherein:
the first input comprises data from a news feed or publicly available business data; and
the second input comprises private business data from a customer relationship management application or from an enterprise resource planning application.

18. The non-transitory computer readable storage medium of claim 15 wherein the score is computed based on an order in which the first input and the second input are entered by a user.

19. The non-transitory computer readable storage medium of claim 15 wherein:
the engine is in an in-memory database; and
the engine references a stored library of the in-memory database during processing of the first input, the second input, and the third input to identify the business lead and to compute the score.

20. The non-transitory computer readable storage medium of claim 19 wherein the one or more programs further store the business lead as a data object including the score and a name of the business lead.
